(19) United States
(12) Patent Application Publication
(10) Pub. No.: US 2024/0343944 A1
(43) Pub. Date: Oct. 17, 2024

(54) Preparation of High Molecular Weight Polymers with Minimal Gel Content

(71) Applicant: 3M INNOVATIVE PROPERTIES COMPANY, St. Paul, MN (US)

(72) Inventors: Ryan B. Prince, St. Paul, MN (US); Adam R. Wohl, Mahtomedi, MN (US); Barbara L. Kellen, Baldwin, WI (US); Alexander J. Kugel, Woodbury, MN (US)

(21) Appl. No.: 18/688,511

(22) PCT Filed: Jul. 27, 2022
(86) PCT No.: PCT/IB2022/056956

§ 371 Date: Mar. 1, 2024

Related U.S. Application Data
(60) Provisional application No. 63/240,251, filed on Sep. 2, 2021.

(51) Int. Cl. C09J 4/00; C08F 2/38; C08F 2/50; C08F 4/44; C08F 220/06; C08F 220/14; C08F 220/18; C08F 222/10; C09J 7/38; C09J 133/08

(52) U.S. Cl. CPC C09J 4/00; C08F 2/38; C08F 2/50; C08F 4/44; C08F 220/06; C08F 220/14; C08F 220/1808; C08F 220/1811; C08F 222/102; C09J 7/385; C09J 133/08; C09J 2301/302; C09J 2301/416; C09J 2433/00

(57) ABSTRACT

Curable precursor compositions for adhesives (e.g., pressure sensitive adhesives) and related articles, assemblies, and methods. The provided compositions contain a mixture comprising 50 to 100 parts by weight of a first polymerizable component, 0 to 50 parts by weight of a second polymerizable component, a transition metal complex soluble in the mixture, and an effective amount of a polymerization initiator, thereby allowing for the formation of high molecular weight polymer with essentially no gel content that can be easily processed via established hot melt techniques (i.e., a hot melt processable adhesive), even in the absence of chain transfer agents or crosslinking agents.

### BACKGROUND

Methods for making packaged viscoelastic compositions in which the packaging material is either retained following polymerization (i.e., a first type of product) or is removed following polymerization and prior to subsequent processing (i.e., a second type of product) are known. For example, U.S. Pat. No. 5,804,610 (Hamer et al.) discloses and describes these two types of products separately, with particular reference to hot melt adhesive compositions (also referred to herein as “hot melt processable adhesives”), though the principles described are equally applicable to other types of viscoelastic compositions, such as, for example, pressure sensitive adhesives generally, hot melt processable sealants, vibration damping materials, and gels for medical applications.

### SUMMARY

Provided herein are compositions containing a mixture including 50 to 100 parts by weight of a first polymerizable component, 0 to 50 parts by weight of a second polymerizable component, a transition metal complex soluble in the mixture, and an effective amount of a polymerization initiator, thereby allowing for the formation of high molecular weight polymer with essentially no gel content that can be easily processed via established hot melt techniques (i.e., a hot melt processable adhesive), even in the absence of chain transfer agents or crosslinking agents.

Also described herein are methods of preparing the disclosed preadhesive compositions, as well as articles including such preadhesive compositions.

As used herein:

“common solvents” refers to low molecular weight organic liquids commonly used as solvents by practitioners in the art, which may include aliphatic and alicyclic hydrocarbons (e.g., hexane, heptane, and cyclohexane), aromatic solvents (e.g., benzene, toluene, and xylene), ethers (e.g., diethyl ether, glyme, diglyme, diisopropyl ether, and tetrahydrofuran), esters (e.g., ethyl acetate and butyl acetate), alcohols (e.g., ethanol and isopropyl alcohol), ketones (e.g., acetone, methyl ethyl ketone, and methyl isobutyl ketone), sulfoxides (e.g., dimethyl sulfoxide), amides (e.g., N,N-dimethylformamide, N,N-dimethylacetamide, and N-methyl-2-pyrrolidone), halogenated solvents (e.g., methylchloroform, 1,1,2-trichloro-1,2,2-trifluoroethane, trichloroethylene, and trifluorotoluene), and mixtures thereof; providing that “common solvents” excludes species that act as monomers or otherwise as reactants in a given composition;

“essentially no” amount of a material in a composition may be substituted with “less than 5 weight percent”, “less than 4 weight percent”, “less than 3 weight percent”, “less than 2 weight percent”, “less than 1 weight percent”, “less than 0.5 weight percent”, “less than 0.1 weight percent”, or “none”;

“expandable polymeric microsphere” refers to a microsphere that includes a polymer shell and a core material in the form of a gas, liquid, or combination thereof, that expands upon heating, where expansion of the core material, in turn, causes the shell to expand, at least at the heating temperature,

“hot melt processable adhesive” means an adhesive comprising essentially no common solvents, which may be hot melt processed under conventional conditions, where hot melt processing includes hot melt blending and extruding;

“pressure sensitive adhesive” or “PSA” means materials having at least the following properties: a) tacky surface, b) the ability to adhere with no more than finger pressure, c) the ability to adhere without activation by any energy source, d) sufficient ability to hold onto the intended adherend, and preferably e) sufficient cohesive strength to be removed cleanly from the adherend; which materials typically meet the Dahlquist criterion of having a storage modulus at 1 Hz and room temperature of less than 0.3 MPa; and

“structural adhesive” means an adhesive that binds by irreversible cure, typically with a strength when bound to its intended substrates, measured as stress at break (peak stress) using a overlap shear test of at least 689 kPa (100 psi), in some embodiments at least 1379 kPa (200 psi), and in some embodiments at least 2067 kPa (300 psi).

All scientific and technical terms used herein have meanings commonly used in the art unless otherwise specified.

As used in this specification and the appended claims, past tense verbs such as “coated” and “embossed” are intended to represent structure, and not to limit the process used to obtain the recited structure, unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open-ended sense, and generally mean “including, but not limited to.” It will be understood that the terms “consisting of” and “consisting essentially of” are subsumed in the term “comprising,” and the like.

Features and advantages of the present disclosure will be further understood upon consideration of the detailed description as well as the appended claims.

### DETAILED DESCRIPTION

It is known to use chain transfer agents and crosslinking agents to prepare packaged viscoelastic compositions having moderate molecular weight, appropriate cohesive strength, and minimal gel content (e.g., less than 5 wt. %) for use in adhesives to balance material performance with processing conditions. However, when high molecular weight polymers (i.e., polymers having an Mz of greater than about 2 million) are produced according to these known methods, a higher gel content may be observed, which can lead to difficulties in processing or an unacceptable coating appearance. Since there is sometimes a need for these higher molecular weight polymers, particularly in pressure sensitive adhesive (“PSA”) applications, these applications have been forced to rely on solvent-made polymers instead of hot melt processable adhesives to achieve the required higher molecular weight range in conjunction with the lower gel content.

As demonstrated in the present disclosure, it was surprisingly found that when a transition metal complex (e.g., a copper (II) salt) that is soluble in the monomer mixture of a preadhesive composition is present during the preparation of a packaged viscoelastic composition, it is possible to form high molecular weight polymer with essentially no gel content that can be easily processed via established hot melt techniques (i.e., a hot melt processable adhesive), even in the absence of chain transfer agents or crosslinking agents.

In one aspect, provided herein are preadhesive compositions including a mixture comprising a first polymerizable component, optionally a second polymerizable component, a transition metal complex soluble in the mixture; and an effective amount of a polymerization initiator.

### First Polymerizable Component

In preferred embodiments of the present disclosure, the preadhesive composition includes a mixture comprising 50 to 100 parts by weight, 70 to 100 parts by weight, 90 to 100 parts by weight, or 100 parts by weight of a first polymerizable component. The first polymerizable component comprises a (meth)acrylic ester of a non-tertiary alkyl alcohol in which the alkyl group includes 1 to 20 carbon atoms, optionally 1 to 18 carbon atoms, optionally 1 to 16 carbon atoms, optionally 1 to 14 carbon atoms, optionally 1 to 12 carbon atoms, optionally 1 to 10 carbon atoms, or optionally 1 to 8 carbon atoms. In some embodiments, the first polymerizable component includes aromatic acrylates such as, for example, benzyl acrylate and cyclobenzyl acrylate. In some preferred embodiments, the first polymerizable component is selected from the group consisting of a primary alkyl (meth)acrylate, a secondary alkyl (meth)acrylate, and combinations thereof. Useful primary alkyl (meth) acrylates and secondary alkyl (meth) acrylates can include, for example, methyl (meth)acrylate, ethyl (meth)acrylate, n-butyl (meth)acrylate, isobornyl acrylate, 2-ethylhexyl acrylate, lauryl acrylate, cyclohexyl acrylate, iso-octyl acrylate, octadecyl acrylate, nonyl acrylate, decyl acrylate, isobornyl acrylate, dodecyl acrylate, 2-propylheptyl acrylate, heptadecanyl acrylate, 2-butyl-1-octyl acrylate made according to Example GM1 of U.S. Pat. No. 8,137,807 (Clapper et al.), C18 acrylate isomer blend made according to Example GM4 of U.S. Pat. No. 8,137,807 (Clapper et al.), as well the alkyl acrylate isomer blends prepared as described in U.S. Pat. No. 9,102,774 (Clapper et al.).

### Second Polymerizable Component

In some embodiments of the present disclosure, the preadhesive composition may include a mixture comprising up to 50 parts by weight, up to 30 parts by weight, up to 10 parts by weight of a second polymerizable component having at least one modifying monomer, other than the (meth)acrylic ester described supra, copolymerizable with the first polymerizable component, where the sum of first polymerizable component and the second polymerizable component is 100 parts by weight. Representative examples of suitable non-acid functional polar monomers suitable for use as the second polymerizable component include, but are not limited to: 2-hydroxyethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates; alkyl vinyl ethers, including vinyl methyl ether; and mixtures thereof. Preferred polar monomers include those selected from the group consisting of 2-hydroxyethyl (meth)acrylate and N-vinylpyrrolidone. In some embodiments, the second polymerizable component may comprise an acid functional monomer, where the acid functional group may be an acid per se, such as a carboxylic acid, or a portion may be salt thereof, such as, for example, an alkali metal carboxylate. Useful acid functional monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, $-carboxyethyl (meth)acrylate, 2-sulfoethyl methacrylate, styrene sulfonic acid, 2-acrylamido-2-methylpropanesulfonic acid, vinylphosphonic acid, and mixtures thereof. Due to their availability, acid functional monomers of the acid functional copolymer are generally selected from ethylenically unsaturated carboxylic acids, i.e. (meth)acrylic acids. When even stronger acids are desired, acidic monomers include the ethylenically unsaturated sulfonic acids and ethylenically unsaturated phosphonic acids. In some preferred embodiments, the second polymerizable component is selected from the group consisting of acrylic acid, N-vinylpyrrolidone, and combinations thereof.

### Transition Metal Complex

Transition metal complexes useful in embodiments of the present disclosure include complexes that are soluble in the mixture of the first polymerizable component and the second polymerizable component described supra. In some preferred embodiments, the transition metal complex comprises copper. In some preferred embodiments the transition metal complex is selected from the group consisting of copper (II) 2-ethylhexanoate, copper (II) acetate, copper (II) acetylacetonate, copper (II) trifluoroacetate, and combinations thereof. Preadhesive compositions of the present disclosure typically include 0.01 wt. % to 0.2 wt. %, optionally 0.02 wt. % to 0.12 wt. % transition metal complex in parts by weight based on the total weight of the mixture comprising the first polymerizable component and, when present, the second polymerizable component.

### Polymerization Initiator

Polymerization initiators useful in embodiments of the present disclosure are known in the art and include Norrish type I photoinitiators such as those available under the trade designations OMNIRAD from IGM Resins (Waalwijk, The Netherlands). Suitable photoinitiators include, for example, 2,2-dimethoxy-1,2-diphenylethan-1-one (OMNIRAD 651), 2-hydroxy-2-methyl-1-phenyl propan-1-one (OMNIRAD 1173), 1-hydroxycyclohexyl phenyl-ketone (ONNIRAD 184), 2,4,6-trimethylbenzoyl-diphenyl phosphine oxide (OMNIRAD TPO), and 2,4,6-trimethylbenzoylphenyl phosphinate (OMNIRAD TPO-L).

Photoinitiator is typically present in the preadhesive compositions in an amount of up to about 1% by weight, based on the total weight of the first polymerizable component and, when present, the second polymerizable component. In some cases, photoinitiator is present in an amount of 0.05 wt. % or more, 0.07 wt. % or more, or 0.1 wt. % or more; and 1 wt. % or less, 0.8 wt. % or less, or 0.6 wt. % or less. Stated another way, the photoinitiator may be present in an amount of about 0.05 to 1% by weight, 0.07 to 0.8% by weight, or 0.1 to 0.6% by weight, based on the total weight of the first polymerizable component and, when present, the second polymerizable component.

### Preadhesive Composition Additives

Various other optional components familiar to those of ordinary skill in the relevant arts can be added to the preadhesive composition such as, for example, a tackifier, a plasticizer, an antioxidant, and combinations thereof. Tackifiers useful in embodiments of the present disclosure are known in the art and may include, for example, ARKON P-125 hydrocarbon resin available from Arakawa Europe GnbH, Germany, CLEARON P150 available from Yasuhara Chemical Co., Japan, and ENDEX 160 available from Eastman Chemical Company, Kingsport, Tennessee. The plasticizing agent is preferably non-volatile and non-reactive. Particularly useful plasticizing agents include, for example, CARBOWAX 750, an acrylate-functional derivative of methoxypolyethylene oxide available from Dow Chemical Co., Midland, MI and PLURONIC 25R4, an ethylene oxide/propylene oxide block copolymer plasticizer available from BASF Company, Ludwigshafen, Germany. Antioxidants may be used to protect against severe environmental aging caused by ultraviolet light or heat. Antioxidants include, for example, hindered phenols, amines, and sulfur and phosphorous hydroxide decomposers. Preferred antioxidants include, for example, IRGANOX 1076 and IRGANOX 1010, available commercially from BASF, Ludwigshafen, Germany. Generally, the amounts of each additive would depend on the intended use of the resulting composition.

### Articles

Preadhesive compositions of the present disclosure may be prepared and processed by methods known to those of ordinary skill in the relevant arts and as described in the Examples infra. A polymerized material comprising the disclosed preadhesive composition can be made, for example, by blending the first polymerizable component, optionally the second polymerizable component, the transition metal complex soluble in the mixture, and the polymerization initiator in a suitable reaction container followed by exposure of the preadhesive composition contained in a sealed film receptacle to ultraviolet (“UV”) radiation. In some preferred embodiments, irradiation can result in greater than 99% conversion of the first polymerizable component and the second polymerizable component to the polymerized material. In some preferred embodiments, the polymerized material is greater than 95% soluble, greater than 96% soluble, greater than 97% soluble, or greater than 98% soluble in ethyl acetate. In some preferred embodiments, the polymerized material has an Mz of 2 million to 4 million. In some preferred embodiments, the polymerized material has an inherent viscosity of 1.2 to 2.3.

Depending on the desired properties of a final product, other additive can also be included in the polymerized material such as, for example crosslinking agents (e.g., 1,6-hexanediol acrylate), chain transfer agents (e.g., an alkene, an alcohol), tackifiers, plasticizers, expandable polymeric microsphere, and combinations thereof. In some embodiments the crosslinking agent reacts under UV light. In some embodiments the crosslinking agent reacts under e-beam radiation. In some embodiments the chain transfer agent does not include a thiol functionality. In some embodiments the chain transfer agent comprises a secondary alcohol. In some embodiments the chain transfer agent comprises an unsaturated hydrocarbon. Useful examples of tackifying resins suitable for embodiments of the present disclosure include but are not limited to liquid rubbers, aliphatic and aromatic hydrocarbon resins, rosin, natural resins such as dimerized or hydrogenated balsams and esterified abietic acids, polyterpenes, terpene phenolics, phenol-formaldehyde resins, and rosin esters. Useful examples of plasticizers include but are not limited to polybutene, paraffinic oils, naphthenic oils, petrolatum, and certain phthalates with long aliphatic side chains such as ditridecyl phthalate. In some embodiments the plasticizer does not include an acrylate functionality. Expandable polymeric microspheres useful in embodiments of the present disclosure include those as described in U.S. Pat. No. 7,879,441 (Gehlen, et al.)

In some embodiments, the polymerized material is a component of an adhesive, such as, for example, a pressure-sensitive adhesive, a structural adhesive, or a hot-melt adhesive. Articles are provided that include such adhesive compositions and a substrate. In some embodiments, a layer of the adhesive composition is positioned adjacent to the substrate. The adhesive composition may directly contact the substrate or may be separated from the substrate by one of more layers such as a primer layer.

Any suitable substrate can be used. In some articles, the substrate is flexible. Examples of flexible substrate materials include, but are not limited to, polymeric films, woven or nonwoven fabrics; metal foils, foams (e.g., polyacrylic, polyethylene, polyurethane), and combinations thereof (e.g., metalized polymeric film). Polymeric films include, for example, polypropylene (e.g., biaxially oriented), polyethylene (e.g., high density or low density), polyvinyl chloride, polyurethane (e.g., thermoplastic polyurethanes), polyester (e.g., polyethylene terephthalate (“PET”), polyethylene naphthalate (“PEN”), and polylactic acid copolymer), polycarbonate, polyacrylate, polymethyl(meth)acrylate (“PMMA”), polyvinylbutyral, polyimide, polyamide, fluoropolymer, cellulose acetate, triacetyl cellulose (TAC), ethyl cellulose, and polycyclic olefin polymers (“COP”). The woven or nonwoven fabric may include fibers or filaments of synthetic or natural materials, such as cellulose, cotton, nylon, rayon, glass, ceramic materials, and the like.

In some embodiments, the article is or contains an adhesive tape. Examples of such adhesive tapes include transfer tapes, one-sided adhesive tapes, two-sided tapes (i.e., a core substrate such as, for example, foam) with an adhesive layer on each side of the substrate, or die-cut adhesive articles (e.g., the article has an adhesive layer positioned adjacent to one release liner or positioned between two release liners). Such adhesive tapes may include a wide variety of substrates for use as a backing or release liner. Examples include woven and nonwoven materials, plastic films, metal foils, and the like.

Adhesive tapes are often prepared by coating an adhesive composition upon a variety of flexible or inflexible backing materials and/or release liners using conventional coating techniques to produce a one-sided tape or a two-sided tape. In the case of a one-sided adhesive tape, the adhesive composition can be coated on a layer of backing material and the side of the backing material opposite that where the adhesive is disposed can be coated with a suitable release material (e.g., a release layer or release liner). Release materials are known and include materials such as, for example, silicone, polyethylene, polycarbamate, polyacrylics, and the like. For two-sided adhesive tape, a first adhesive composition is coated on a layer of backing material and a second layer of adhesive composition is disposed on the opposing surface of the backing material. The second layer may include the adhesive compositions as described herein or a different adhesive composition. For a die-cut adhesive article or for a transfer tape, the adhesive composition is typically positioned between two release liners. The adhesive articles can also be part of another article. For example, the adhesive composition can bind two parts of an article together.

Objects and advantages of this disclosure are further illustrated by the following non-limiting examples, but the particular materials and amounts thereof recited in these examples, as well as other conditions and details, should not be construed to unduly limit this disclosure.

### Examples

Unless otherwise noted or readily apparent from the context, all parts, percentages, ratios, etc. in the Examples and the rest of the specification are by weight.

Materials Used in the Examples

| Abbreviation | Description |
|---|---|
| AA | Acrylic acid, obtained from Alfa Aesar, Heysham, England |
| IOA | Isooctyl acrylate, made in-house at 3M by standard procedures |
| MA | Methyl acrylate, obtained from Dow Chemical Company, |
| | Midland Michigan |
| IBOA | Isobornyl acrylate, obtained from Allnex, Alpharetta, Georgia |
| ISOMER MIX A | A mixture of 2-octyl acrylate, 3-octyl acrylate, and 4-octyl |
| | acrylate, prepared as in Example 1 of U.S. Pat. No. 9,102,774 |
| | (Clapper et al.) |
| OMNIRAD 651 | 2,2-Dimethoxy-2-phenylacetophenone, formerly known as |
| | “IRGACURE 651”, a photoinitiator obtained under the trade |
| | designation “OMNIRAD 651” from IGM Resins USA, Inc., |
| | Charlotte, NC |
| TPO-L | Ethyl(2,4,6-trimethylbenzoyl)-phenyl phosphinate, a |
| | photoinitiator obtained under the trade designation |
| | “OMNIRAD TPO-L” from IGM Resins USA, Inc., Charlotte, |
| | NC |
| OMNIRAD 1173 | 2-Hydroxy-2-methyl-1-phenylpropanone, formerly known as |
| | “IRGACURE 1173”, a photoinitiator obtained under the trade |
| | designation “OMNIRAD 1173” from IGM Resins USA, Inc., |
| | Charlotte, NC |
| Cu(OAc)₂ | Copper (II) acetate, obtained from Alfa Aesar, Ward Hill, MA |
| Copper (2-ethylhexanoate) | Copper (II) (2-ethylhexanoate), obtained from ChemCeed, |
| | LLC, Chippewa Falls, WI |
| Octene | 1-Octene, obtained from Alfa Aesar, Ward Hill, MA |
| Octanol | 2-Octanol, obtained from Alfa Aesar, Ward Hill, MA |
| Ethyl Acetate | Ethyl acetate, obtained from Honeywell, Charlotte, NC |
| THF | Tetrahydrofuran stabilized with 250 ppm BHT, obtained from |
| | MilliporeSigma Co., Burlington, MA |
| KAEBP | Ketalated acryloxyethoxybenzophenone, prepared generally as |
| | described in Example 1 of U.S. Pat. No. 10,189,771 (Benson |
| | et al.) |
| VAZO 67 | 2,2′-Azobis(2-methylbutyronitrile), obtained under the trade |
| | designation “VAZO 67” from The Chemours Co., |
| | Wilmington, DE |
| IRGANOX 1076 | Octadecyl-3-[3,5-di-tert-butyl-4-hydroxyphenyl]propionate, |
| | an antioxidant obtained under the trade designation |
| | “IRGANOX 1076” from BASF, Ludwigshafen, Germany |
| HDDA | 1,6-Hexanediol acrylate, obtained under the trade designation |
| | “LAROMER HDDA” from BASF Corp, Florham Park, NJ |
| EVA film | A clear poly(ethylene vinyl acetate) film, 0.065 mm thick, |
| | which was produced using a blown film process from an EVA |
| | copolymer resin obtained under the trade designation |
| | “ELEVATE EF546AA” from Westlake Chemical |
| | Corporation, Houston, TX |
| ARKON P-125 | Water white, hydrocarbon resin obtained under the trade |
| | designation “ARKON P-125” from Arakawa Chemical, |
| | Chicago, IL |
| PLURONIC 25R4 | Difunctional block copolymer surfactant with terminal |
| | secondary hydroxyl groups obtained under the trade |
| | designation “PLURONIC 25R4” from BASF, Ludwigshafen, |
| | Germany |
| CARBOWAX 750 | Acrylate-functional derivative of methoxypolyethylene oxide, |
| | obtained under the trade designation “CARBOWAX 750” |
| | from Dow Chemical Co., Midland, MI |

### Preparation of “100% Solids” or “Bulk” Polymers Used in the Examples

Monomer mixtures were prepared by blending reactive acrylic monomers, photoinitiator, antioxidant, and copper (II) salt in ajar. To this mixture was added a magnetic stir bar, and the mixture was placed on a stir plate, forming a curable composition. EVA film was heat sealed to form open ended receptacles each measuring 18 cm by 5 cm. Each receptacle was filled with approximately 24 grams of the curable composition. Air was forced out of the open end which was then sealed using a heat sealer (obtained under the trade designation “MIDWEST PACIFIC IMPULSE SEALER” from J. J. Elemer Corp., St. Louis, MO). A sealed EVA film receptacle having the curable composition enclosed within the was immersed in a constant temperature water bath at 16° C. and irradiated with ultraviolet light (365 nm, 4.5 mW/cm²) for nine minutes on each side to polymerize the curable composition. Polymerized samples were removed from the EVA film receptacle for testing, as described below.

### Test Methods

### Test Method 1: Determination of Gel Content

A rectangular polymer sample of approximately 24 g was placed onto the center of a pre-weighed rectangular mesh. The mesh was a square weave wire cloth, stainless steel type 304, of woven construction, 150 mesh, using 0.0026 inch (66 micrometer) wire, and 0.0041 inch (104 micrometer) openings (obtained under the trade designation “MCMASTER-CARR”, from McMaster-Carr Co., Elmhurst, IL). The overhanging portion of the mesh was folded inwards to cover and immobilize the sample inside the mesh. The folded mesh with the enclosed polymer was weighed and then immersed in approximately 8 oz. (approx. 240 ml) of ethyl acetate inside a glass jar that was placed on a mechanical roller for 24 hours. The mesh with the polymer was then taken out of the jar and dried in an oven for 30 minutes at 120° C. and weighed again to calculate the sample mass. The gelled insoluble portion of the polymer was calculated as a gel weight percent (“gel wt. %”) using the following equation:

$$Gel Wt . \% = \frac{( final weight of undissolved polymer + mesh ) - ( weight of mesh )}{( initial weight of polymer + mesh ) - ( weight of mesh )} \times 100$$

### Test Method 2: Determination of Percent Solids

A sample (0.5 g to 2.0 g) of test material was weighed and placed in a small aluminum open container and kept in a convection oven (obtained under the trade designation “SYMPHONY” from VWR Corporation, Radnor, PA) at approximately 105° C. overnight to provide a dried sample. The weight of the dried sample was measured and recorded. By the measured weight loss of the evaporated monomer, the amount of monomer converted to polymer was calculated and expressed as a weight percent (wt. %).

### Test Method 3: Determination of Inherent Viscosity (“IV”)

The inherent viscosities (“IVs”) reported herein were obtained by conventional methods known to those of ordinary skill in the art. The IVs were obtained using a single-bath dilute solution polymer viscometer (obtained under the trade designation “MINIPV-X” from Cannon Instrument Co., State College, PA) in a water bath controlled at 27° C., to measure the flow time of 10 mL of a polymer solution (0.3 g/dL polymer in ethyl acetate). The test procedure that was followed and the apparatus used are described in detail in Textbook of Polymer Science, F. W. Billmeyer, Wiley-Interscience, Second Edition, 1971, Pages 84 and 85.

### Test Method 4: GPC Analysis

Approximately 50 mg of polymeric solids was placed in 10 mL of THF (stabilized with 250 ppm BHT). The samples were mixed at low speed for approximately three hours on a mechanical shaker (obtained under the trade designation E6010.00 from Eberbach Corporation, Belleville, MI) to provide polymer solutions. All polymer solutions were run through a 0.45 micron syringe filter and analyzed by Gel Permeation Chromatography (“GPC”). The GPC consists of a Pump, Columns and a Detector. The Columns and Detector are described below. The Pump was obtained under the trade designation “AGILENT 1100 HPLC” from Agilent Technologies, Santa Clara, CA. The samples were prepared and analyzed in duplicate, and the average of the two values was reported.

### GPC Equipment and Conditions:

Sample: 50 μL Injection at 5 mg/mL Tetrahydrofuran-stabilized
   Sample filtered through 0.45 micron membrane
Mobile Phase: Tetrahydrofuran-UV Grade, stabilized (obtained under the trade designation “EMD OMNISOLV” from MilliporeSigma Co., Burlington, MA); or equivalent grade
Flow Rate: 1.0 mL/min
Detector: Refractive Index Detector (obtained under the trade designation “1200 SERIES G1362” from Agilent Technologies, Santa Clara, CA)
Columns: Two of nominal MW range 500-10⁷ Daltons (obtained under the trade designation “PLGEL 10 MICRON MIXED-B” from Agilent Technologies, Santa Clara, CA) and one of nominal MW range 200-400,000 Daltons, (obtained under the trade designation “PLGEL 5 MICRON MIXED-D” from Agilent Technologies). All columns are 7.8 mm×300 mm. Columns are held at 40° C.
Standards: Polystyrene, narrow dispersity; ranging 6.035×10⁶−580 Mp; (third order polynomial fit) obtained under the trade designation “EASICAL PS-1” from Agilent, Santa Clara, CA
Syringe filter type: 0.45 micron PTFE

### Abbreviations

Mw=Weight-average molecular weight
Mn=Number-average molecular weight
Mz=Z-average molecular weight
Polydispersity=Mw/Mn, a figure related to the width of the distribution curve

### Comparative Example CE1 and Examples 2-6: Preparation and Analysis of High Molecular Weight Polymers with Minimal Gel Content

For each Example, the general procedure for “Preparation of ‘100% Solids’ or ‘Bulk’ Polymers” was followed by using the amounts (in parts by weight based on the total weight of ISOMER MIX A and AA) listed in Table 1 to provide Comparative Example (CE-1) and five Examples (Exs. 2-6).

TABLE 1
Compositions with Varying Amounts of HDDA

| | ISOMER | | OMNIRAD | IRGANOX | | Copper (2- |
|---|---|---|---|---|---|---|
| Example | MIX A | AA | 651 | 1076 | HDDA | ethylhexanoate) |
| CE-1 | 90 | 10 | 0.15 | 0.4 | 0 | 0 |
| 2 | 90 | 10 | 0.15 | 0.4 | 0.001 | 0.12 |
| 3 | 90 | 10 | 0.15 | 0.4 | 0.003 | 0.12 |
| 4 | 90 | 10 | 0.15 | 0.4 | 0.005 | 0.12 |
| 5 | 90 | 10 | 0.15 | 0.4 | 0.007 | 0.12 |
| 6 | 90 | 10 | 0.15 | 0.4 | 0.009 | 0.12 |

GPC Analysis was performed on each of CE-1 and Examples 2-6. Results are summarized in Table 2.

TABLE 2
GPC Analysis

| Example | Mw | Mn | Mz | Polydispersity |
|---|---|---|---|---|
| CE-1 | 8.96E+05 | 1.46E+05 | 2.78E+06 | 6.15 |
| 2 | 8.27E+05 | 2.00E+05 | 2.40E+06 | 4.15 |
| 3 | 8.77E+05 | 2.08E+05 | 2.72E+06 | 4.23 |
| 4 | 9.39E+05 | 2.02E+05 | 2.93E+06 | 4.66 |
| 5 | 1.04E+06 | 1.96E+05 | 3.47E+06 | 5.30 |
| 6 | 1.13E+06 | 2.12E+05 | 3.74E+06 | 5.33 |

Gel content and Inherent Viscosity (“IV”) measurements were performed on each of CE-1 and Examples 2-6. Results are summarized in Table 3.

TABLE 3
Gel Content and Inherent Viscosity

| Example | IV | Gel Wt. % |
|---|---|---|
| CE-1 | 1.247 | 6.7 +/− 1.2 |
| 2 | 1.294 | 0.04 +/− 0.06 |
| 3 | 1.399 | 0.04 +/− 0.06 |
| 4 | 1.383 | 0.10 +/− 0.03 |
| 5 | 1.519 | 0.4 +/− 0.3 |
| 6 | 1.686 | 5.8 +/− 2.7 |

### Examples 7-10: Preparation and Analysis of High Molecular Weight Polymers with Minimal Gel Content and Inherent Viscosity Greater Than 1.8

Examples were made according to the general procedure for “Preparation of ‘100% Solids’ or ‘Bulk’ Polymers” except that the starting materials and their amounts (in parts by weight based on the total weight of IOA, MA, and AA) were as indicated in Table 4.

TABLE 4
Compositions of Polymers Leading to an Inherent Viscosity Greater Than 1.8

| | | | | OMNIRAD | IRGANOX | | Copper (2- |
|---|---|---|---|---|---|---|---|
| Example | IOA | MA | AA | 651 | 1076 | HDDA | ethylhexanoate) |
| 7 | 57.5 | 35 | 7.5 | 0.40 | 0.4 | 0 | 0.12 |
| 8 | 57.5 | 35 | 7.5 | 0.25 | 0.4 | 0 | 0.12 |
| 9 | 57.5 | 35 | 7.5 | 0.15 | 0.4 | 0.003 | 0.12 |
| 10 | 57.5 | 35 | 7.5 | 0.25 | 0.4 | 0.003 | 0.12 |

Gel content and Inherent Viscosity (“IV”) measurements were performed on each of Examples 7-10. Results are summarized in Table 5.

TABLE 5
IV and Gel Content of IOA/MA/AA Polymers Produced

| Example | IV | Gel Wt. % |
|---|---|---|
| 7 | 1.877 | 0.21 +/− 0.01 |
| 8 | 1.835 | 0.39 +/− 0.20 |
| 9 | 2.221 | 0 +/− 0 |
| 10 | 2.053 | 0.52 +/− 0.32 |

### Examples 11-12: Preparation and Analysis of High Molecular Weight Polymers Including IOA with Minimal Gel Content

Examples were made following the general procedure for “Preparation of ‘100% Solids’ or ‘Bulk’ Polymers” except that the amounts of materials (in parts by weight based on the total weight of IOA and AA) were as indicated in Table 6.

TABLE 6
Effects of Copper (II) on IOA-Containing Formulation

| | | | OMNIRAD | IRGANOX | | Copper (2- |
|---|---|---|---|---|---|---|
| Example | IOA | AA | 651 | 1076 | HDDA | ethylhexanoate) |
| 11 | 90 | 10 | 0.15 | 0.4 | 0.005 | 0 |
| 12 | 90 | 10 | 0.15 | 0.4 | 0.005 | 0.12 |

Gel content and Inherent Viscosity (“IV”) measurements were performed on each of Examples 7-10. Results are summarized in Table 7.

TABLE 7
IV and Gel content of IOA/AA Polymers Produced

| Example | IV | Gel Wt. % |
|---|---|---|
| 11 | 1.667 | 41.6 +/− 0.8 |
| 12 | 1.635 | 1.5 +/− 0.9 |

### Examples 13-16: Preparation and Analysis of High Molecular Weight Polymers with Minimal Gel Content Made with Various Cu (II) Sources

Examples were made following the general procedure for “Preparation of ‘100% Solids’ or ‘Bulk’ Polymers” except that the amounts of materials (in parts by weight based on the total weight of ISOMER MIX A and AA) were as indicated in Table 8.

TABLE 8
Effects of Alternate Copper (II) Sources

| | ISOMER | | OMNIRAD | IRGANOX | | | Copper (2- |
|---|---|---|---|---|---|---|---|
| Example | MIX A | AA | 651 | 1076 | HDDA | Cu(OAc)₂ | ethylhexanoate) |
| 13 | 90 | 10 | 0.15 | 0.4 | 0.005 | 0 | 0 |
| 14 | 90 | 10 | 0.15 | 0.4 | 0.005 | 0 | 0.12 |
| 15 | 90 | 10 | 0.15 | 0.4 | 0.005 | 0.06 | 0 |
| 16 | 90 | 10 | 0.15 | 0.4 | 0.005 | 0.12 | 0 |

Gel content and Inherent Viscosity (“IV”) measurements were performed on each of Examples 13-16. Results are summarized in Table 9.

TABLE 9
IV and Gel Content of Polymers Produced
Using Various Copper (II) Sources

| Example | IV | Gel Wt. % |
|---|---|---|
| 13 | 1.440 | 12.2 +/− 1.6 |
| 14 | 1.383 | 0.10 +/− 0.03 |
| 15 | 1.552 | 0.10 +/− 0.15 |
| 16 | 1.437 | 2.18 +/− 0.19 |

### Examples 17-22: Preparation and Analysis of UV-Cured High Molecular Weight Polymers

Examples were made following the general procedure for “Preparation of ‘100% Solids’ or ‘Bulk’ Polymers” except that the amounts of materials (in parts by weight based on the total weight of ISOMER MIX A and AA) were as indicated in Table 10.

TABLE 10
Samples Prepared to Assess the Efficiency of UV Curing of the Examples

| | ISOMER | | OMNIRAD | IRGANOX | | Copper (2- |
|---|---|---|---|---|---|---|
| Example | MIX A | AA | 651 | 1076 | KAEBP | ethylhexanoate) |
| 17-19 | 90 | 10 | 0.15 | 0.4 | 0.25 | 0 |
| 20-22 | 90 | 10 | 0.15 | 0.4 | 0.25 | 0.12 |

UV curing of materials with and without the presence of Cu(2-ethylhexanoate) was examined. A sample of material from Table 10 was compounded in a twin screw extruder at 160° C. for three minutes. The resulting hotmelt was coated onto a silicone release liner using a drop die. The extrusion temperatures for the die and extruder were kept at 160° C. The extruded samples were coated at 3 mil (76 micrometers) thickness. The samples were later laminated onto PET film (obtained under the trade designation “HOSTAPHAN 3SAB” from Mitsubishi Polyester Film, Inc., Greer, SC) and cured at multiple UV-C doses, as shown in Table 11, using a UV fusion lamp and H-bulb. Gel content measurements were performed on each of Examples 17-22 cured at the given UV-C radiation. The gel wt. % were measured and the results are summarized in Table 11.

TABLE 11
Gel Content Resulting from UV-C Curing

| Example | UV-C Dose (mJ) | Gel Content (wt. %) |
|---|---|---|
| 17 | 20 | 78.6 +/− 1.5 |
| 18 | 40 | 82.2 +/− 1.5 |
| 19 | 80 | 85.1 +/− 0.6 |
| 20 | 20 | 76.7 +/− 4.2 |
| 21 | 40 | 80.9 +/− 0.8 |
| 22 | 80 | 84.2 +/− 2.8 |

### Examples 23-26: Preparation and Analysis of E-Beam Cured High Molecular Weight Polymers

Examples were made following the general procedure for “Preparation of ‘100% Solids’ or ‘Bulk’ Polymers” except that the amounts of materials (in parts by weight based on the total weight of IOA, MA, and AA) were as indicated in Table 12.

TABLE 12
Samples Prepared to Assess the Efficiency of E-Beam Curing of the Examples

| | | | | OMNIRAD | IRGANOX | 2- | Copper (2- |
|---|---|---|---|---|---|---|---|
| Example | IOA | MA | AA | 651 | 1076 | Octanol | ethylhexanoate) |
| 23 and24 | 57.5 | 35 | 7.5 | 0.25 | 0.4 | 0.25 | 0.12 |
| 25 and 26 | 57.5 | 35 | 7.5 | 0.25 | 0.4 | 1 | 0.12 |

E-beam curing of the materials was examined. A sample of a material from Table 12 was compounded in a twin screw extruder at 160° C. The resulting hotmelt was coated onto a silicone release liner using a drop die. The extrusion temperatures for the die and extruder were kept at 160° C. The extruded samples were coated at 3 mil (approx. 76 micrometers) thickness. The samples were later laminated onto PET film (obtained under the trade designation “HOSTAPHAN 3SAB” from Mitsubishi Polyester Film, Inc., Greer, SC) and cured at a variety of e-beam doses, using an e-beam generating apparatus. Gel content measurements were performed on each of Examples 23-26. E-beam doses and gel wt. % results as summarized in Table 13.

TABLE 13
Gel Content after E-Beam Curing

| Example | E-Beam Dose (mRad) | Gel Content (wt. %) |
|---|---|---|
| 23 | 3 | 78.2 +/− 1.8 |
| 24 | 6 | 89.3 +/− 0.6 |
| 25 | 3 | 75.3 +/− 0.8 |
| 26 | 6 | 85.4 +/− 0.6 |

### Examples 27-29: Preparation and Analysis of High Molecular Weight Polymers Including an Alkene Chain Transfer Agent

Examples were made following the general procedure for “Preparation of ‘100% Solids’ or ‘Bulk’ Polymers” except that the amounts of materials (in parts by weight based on the total weight of IOA, MA, and AA) were as indicated in Table 14 and an unsaturated hydrocarbon was additionally included in the formulation.

TABLE 14
Formulations Including an Alkene Chain Transfer Agent

| | | | | OMNIRAD | Irganox | | Copper (2- |
|---|---|---|---|---|---|---|---|
| Example | IOA | MA | AA | 651 | 1076 | Octene | ethylhexanoate) |
| 27 | 57.5 | 35 | 7.5 | 0.25 | 0.4 | 0.00 | 0.12 |
| 28 | 57.5 | 35 | 7.5 | 0.25 | 0.4 | 0.25 | 0.12 |
| 29 | 57.5 | 35 | 7.5 | 0.25 | 0.4 | 1.00 | 0.12 |

Gel content and Inherent Viscosity (“IV”) measurements were performed on each of Examples 27-29. Results are summarized in Table 15.

TABLE 15
IV and Gel Content of Polymers Including
an Alkene Chain Transfer Agent

| Example | IV | Gel Wt. % |
|---|---|---|
| 27 | 1.835 | 0.39 +/− 0.20 |
| 28 | 1.671 | 0.04 +/− 0 |
| 29 | 1.528 | 0.06 +/− 0.03 |

### Examples 30-32: Preparation and Analysis of High Molecular Weight Polymers Including an Alcohol Chain Transfer Agent

Examples were made following the general procedure for “Preparation of ‘100% Solids’ or ‘Bulk’ Polymers” except that the amounts of materials (in parts by weight based on the total weight of IOA, MA, and AA) were as indicated in Table 16 and an alcohol was added as a chain transfer agent.

TABLE 16
Formulations Including an Alcohol Chain Transfer Agent

| | | | | OMNIRAD | IRGANOX | 2- | Copper (2- |
|---|---|---|---|---|---|---|---|
| Example | IOA | MA | AA | 651 | 1076 | octanol | ethylhexanoate) |
| 30 | 57.5 | 35 | 7.5 | 0.25 | 0.4 | 0.00 | 0.12 |
| 31 | 57.5 | 35 | 7.5 | 0.25 | 0.4 | 0.25 | 0.12 |
| 32 | 57.5 | 35 | 7.5 | 0.25 | 0.4 | 1.00 | 0.12 |

Gel content and Inherent Viscosity (“IV”) measurements were performed on each of Examples 30-32. Results are summarized in Table 17.

TABLE 17
IV and Gel Content of Polymers Including
an Alcohol Chain Transfer Agent

| Example | IV | Gel Wt. % |
|---|---|---|
| 30 | 1.835 | 0.39 +/− 0.20 |
| 31 | 1.883 | 1.67 |
| 32 | 1.648 | 2.32 |

### Examples 33-34: Preparation and Analysis of High Molecular Weight Polymers Including a Tackifier

Examples were made following the general procedure for “Preparation of ‘100% Solids’ or ‘Bulk’ Polymers” except that the amounts of materials (in parts by weight based on the total weight of ISOMER MIX A and AA) were as indicated in Table 18 and Arkon P125 was added to the mixture as a tackifier.

TABLE 18
Formulations Including Tackifier

| | ISOMER | | OMNIRAD | IRGANOX | Arkon | Copper (2- |
|---|---|---|---|---|---|---|
| Example | MIX A | AA | 651 | 1076 | P125 | ethylhexanoate) |
| 33 | 90 | 10 | 0.15 | 0.4 | 20 | 0.12 |
| 34 | 90 | 10 | 0.15 | 0.4 | 0 | 0.12 |

Example 33 was found to fully polymerize even in the presence of both a copper salt and a tackifier. Gel content and Inherent Viscosity (“IV”) measurement was performed on Example 33. Results are summarized in Table 19.

TABLE 19
IV and Gel Content of Polymers Produced
in the Presence of a Tackifier

| Example | IV | Gel Wt. % |
|---|---|---|
| 33 | 0.773 | 1.24 +/− 0.19 |

A portion of Example 34 (100 grams) was compounded in a single screw extruder at 160° C. with Arkon P-125 (20 grams) for three minutes. The resulting hotmelt was coated onto a silicone release liner using a drop die. The extrusion temperatures for the die and extruder were kept at 160° C. The extruded samples were coated at 3 mil (76 micrometers) thickness. The material was observed to be homogeneous.

### Examples 35-36: Preparation and Analysis of High Molecular Weight Polymers Including a Plasticizer

Examples were made following the general procedure for “Preparation of ‘100% Solids’ or ‘Bulk’ Polymers” except that the amounts of materials (in parts by weight based on the total weight of ISOMER MIX A and AA with either PLURONIC 25R4 or CARBOWAX 750) were as indicated in Table 20. CARBOWAX 750 was added as a reactive plasticizer and PLURONIC 25R4 was added as a functional plasticizer.

TABLE 20
Formulations Including Plasticizer

| | ISOMER | | OMNIRAD | IRGANOX | PLURONIC | CARBOWAX | Copper (2- |
|---|---|---|---|---|---|---|---|
| Example | MIX A | AA | 651 | 1076 | 25R4 | 750 | ethylhexanoate) |
| 35 | 72 | 8 | 0.15 | 0.4 | 20 | 0 | 0.12 |
| 36 | 85 | 10 | 0.15 | 0.4 | 0 | 5 | 0.12 |

Gel content and IV measurements were performed on each sample with IV and gel wt. % results as summarized in Table 21.

TABLE 21
IV and Gel Content of Polymers Produced
in the Presence of a Plasticizer

| Example | IV | Gel Wt. % |
|---|---|---|
| 35 | 0.565 | 0.33 +/− 0.64 |
| 36 | 1.550 | 16.22 +/− 3.09 |

A portion of Example 34 (100 grams) was compounded in a single screw extruder at 160° C. with PLURONIC 25R4 (20 grams) for three minutes. The resulting hotmelt was coated onto a silicone release liner using a drop die. The extrusion temperatures for the die and extruder were kept at 160° C. The extruded samples were coated at 3 mil (76 micrometers) thickness. The material was observed to be homogeneous.

### Comparative Example CE-37-CE-40: Solution Polymers Prepared in the Presence of Cu (II) Salts

Solution Polymerization Method: In a 250 ml amber bottle was added ISOMER MIX A, AA, Cu(2-ethylhexanoate), HDDA, and Vazo 67, using the relative amounts shown in Table 22 (in parts by weight based on the total weight of ISOMER MIX A, AA, and IBOA).

TABLE 22
Solution Polymerization Formulations

| | ISOMER | | | Vazo | Copper (2- |
|---|---|---|---|---|---|
| Example | MIX A | AA | IBOA | 67 | ethylhexanoate) |
| CE-37 | 85 | 5 | 10 | 0.20 | 0 |
| CE-38 | 85 | 5 | 10 | 0.20 | 0.06 |
| CE-39 | 85 | 5 | 10 | 0.20 | 0.12 |
| CE-40 | 85 | 5 | 10 | 0.20 | 0.24 |

Ethyl acetate (100 g) was added to the bottle, which was sufficient to result in an approximately 50% solids after reaction. The contents of the bottle were thoroughly mixed and degassed by bubbling a constant stream of nitrogen gas through the solution for two minutes. Then the bottle was sealed and polymerized in a water bath at 65° C. for 24 hours. After 24 hours, the bottle was removed and the resulting polymer in solution was analyzed by determining the percent monomer conversion and IV values. Results as summarized in Table 23.

TABLE 23
Results of Analysis of Polymers Produced in Solvent

| Example | IV | % Conversion |
|---|---|---|
| CE-37 | 0.833 | 98.76% |
| CE-38 | 0.665 | 98.96% |
| CE-39 | 0.534 | 98.10% |
| CE-40 | 0.414 | 94.93% |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A preadhesive composition comprising:
a mixture comprising:
(a) 50 to 100 parts by weight of a first polymerizable component comprising at least one (meth)acrylic ester of a non-tertiary alkyl alcohol in which the alkyl group includes 1-20 carbon atoms; and
(b) 0 to 50 parts by weight of a second polymerizable component comprising at least one modifying monomer, other than the (meth)acrylic ester, copolymerizable with component (a), wherein the sum of (a)+(b) is 100 parts by weight;
a transition metal complex soluble in the mixture; and
an effective amount of a polymerization initiator.

2. The preadhesive composition of claim 1, wherein the first polymerizable component is selected from the group consisting of a primary alkyl (meth)acrylate, a secondary alkyl (meth)acrylate, and combinations thereof.

3. The preadhesive composition of claim 1, wherein first polymerizable component alkyl group includes from 1 to 18 carbon atoms.

4. The preadhesive composition of claim 1, wherein the second polymerizable component is selected from the group consisting of acrylic acid, n-vinylpyrrolidone, and combinations thereof.

5. The preadhesive composition of claim 1, wherein the transition metal complex comprises copper.

6. The preadhesive composition of claim 5, wherein the transition metal complex is selected from the group consisting of copper (II) 2-ethylhexanoate, copper (II) acetate, copper (II) acetylacetonate, copper (II) trifluoroacetate, and combinations thereof.

7.-9. (canceled)

10. A polymerized material comprising the preadhesive composition of claim 1.

11. The polymerized material of claim 10, wherein there is greater than 99% conversion of the first polymerizable component and the second polymerizable component to the polymerized material as determined by Test Method 2.

12. The polymerized material of claim 10, wherein the polymerized material is greater than 95% soluble in ethyl acetate as determined by Test Method 1.

13. The polymerized material of claim 10, wherein the polymerized material has an Mz of 2 million to 4 million as determined by Test Method 4 and an inherent viscosity of 1.2 to 2.3 as determined by Test Method 3.

14. The polymerized material of claim 10, further comprising an additive selected from the group consisting of a crosslinking agent, a chain transfer agent, a tackifier, a plasticizer, an expandable polymeric microsphere, and combinations thereof.

15. The polymerized material of claim 14, wherein the crosslinking agent reacts under UV light.

16. The polymerized material of claim 14, wherein the crosslinking agent reacts under e-beam radiation.

17. The polymerized material of claim 14, wherein the chain transfer agent does not include a thiol functionality.

18. The polymerized material of claim 14, wherein the chain transfer agent comprises a secondary alcohol

19. The polymerized material of claim 14, wherein the chain transfer agent comprises an unsaturated hydrocarbon.

20. The polymerized material of claim 14, wherein the plasticizer does not include an acrylate functionality.

21. A pressure-sensitive adhesive comprising the polymerized material of claim 10.

22. A structural adhesive comprising the polymerized material of claim 10.

23. A tape comprising the polymerized material of claim 10.
